(19) United States
(12) Patent Application Publication
(10) Pub. No.: US 2026/0000580 A1
(43) Pub. Date: Jan. 1, 2026

(54) TESTING METHOD AND APPARATUS

(71) Applicant: Kent Consumer Brands Americas, LLC, Muscatine, IA (US)

(72) Inventors: Neil Turner, Lisle, IL (US); Michael Coladipietro, Crest Hill, IL (US)

(21) Appl. No.: 18/757,785

(22) Filed: Jun. 28, 2024

(51) Int. Cl. A61J 15/00

(52) U.S. Cl. CPC A61J 15/008

(57) ABSTRACT

A method of administering a liquid food product to one or more dysphagic patients comprises introducing liquid food product into a measuring apparatus, the measuring apparatus comprising a stand supporting a fluid container and a valve, and a receptacle disposed beneath the fluid container; actuating the valve to release liquid food product from the fluid container into the receptacle for a predetermined time period; measuring the amount of liquid food product remaining in the fluid container; and from this determining whether the liquid food product is of a viscosity appropriate for the one or more dysphagic patients. The apparatus described herein is also useful in evaluating viscosity or flowability of other materials.

### FIELD

The disclosure is in the field of testing methods and devices. Many embodiments are drawn to testing methods and devices for determining the viscosity of a thickened food product for administration to a dysphagic patient.

### BACKGROUND

Dysphagia is a serious medical condition characterized by difficulty in swallowing. It is known to administer thickened liquid food products, including thickened beverages and other liquid foods such as soups, to dysphagic patients to assist in swallowing.

It would be useful to provide caregivers, such as the staff of a nursing home or other care facility, with a method for evaluating the viscosity of a liquid food product. Direct methods for measuring viscosity are often inaccessible to such caregivers, however. Also, the flow of liquid food products through the mouth and throat of a dysphagic patient consumed can be influenced by many variables, including not only absolute viscosity but also the temperature of the liquid food product, ambient pressure, the density of the liquid food product as prepared, and the like. Thus, the absolute viscosity of a liquid food product as measured under controlled laboratory conditions might only serve as a rough proxy for the suitability of the product in actual use.

In recognition of the above, the International Dysphagia Diet Standardization Initiative has published a Framework and associated Framework Testing Method (current as of version 2.0, 2019 as of the date of filing of this application). This Testing Method and Framework provide a methodology for measuring the viscosity of beverages and other liquid food products. The IDDSI Framework employees a gravity flow test using a 10 mL slip tip or luer lock syringe to quantify the liquid flow's category. This Framework is intended to represent the way a liquid moves when swallowed, and to provide a test that is simple to perform and whose results may be quickly interpreted.

Under the IDDSI Framework, the Testing Method employs a graduated syringe of 10 mL in length corresponding to ISO 7886-1:2017. Using such a syringe, 10mL of a fluid to be measured are introduced into the syringe with the tester's finger covering the base of the syringe. Fluid is allowed to be released from the syringe for a period of 10 seconds, and, at the end of 10 seconds, the amount of fluid remaining in the syringe is measured. The fluid is then assigned a score according to the following scale:
0-1 mL left in syringe: thin
1-4 mL left in syringe: slightly thick
4-8 mL left in syringe: mildly thick
8-10 mL left in syringe: moderately thick
10 mL left in syringe: extremely thick
   From this scale, the suitability of the liquid food product for a dysphagic patient or for a cohort of dysphagic patients can be determined. The IDDSI Framework has proved advantageous because it provides a simple test that can be performed in situ and under the temperature and other conditions of intended delivery of the liquid food product.

Nonetheless, the IDDSI methodology is prone to certain inaccuracies. The test relies on the coordination and reflexes of the person performing the test. There is data to demonstrate that this can lead to different scores depending on the person conducting the test, which is not ideal.

Now provided is a testing method and system that is particularly suitable for use in connection with IDDSI evaluations but that is also more broadly applicable in use. A method of administering a liquid food product to one or more dysphagic patients comprises introducing an aliquot of the liquid food product into a measuring apparatus, the measuring apparatus having a stand, a fluid container, and a valve, and a receptacle disposed beneath the fluid container. The valve is actuated to release liquid food product from the fluid container into the receptacle for a predetermined time. The amount of liquid food product remaining in the fluid container is measured and from this a determination is made as to whether the liquid food product has a viscosity appropriate for the one or more dysphagic patients. The liquid food product is administered to the one or more dysphagic patients only if the liquid food product is of an appropriate viscosity.

A viscosity testing apparatus in accordance with the disclosure comprises a stand supporting a fluid container and a timer-controlled valve, and a receptacle disposed beneath the fluid container. In practice, as provided hereinbelow, the apparatus may be equipped with many other features, such as a temperature sensor configured to evaluate the temperature of liquid food inside the container. The viscosity testing apparatus is useful in other viscosity measuring contexts and for measuring viscosity or flowability of other substances.

### BRIEF DESCRIPTION OF THE DRAWINGS

FIG. 1 is a perspective view of a first embodiment of a testing apparatus in accordance with the disclosure, the apparatus shown with a commercial syringe placed in a testing position.

FIG. 2 is a perspective view of a second embodiment of a testing apparatus in accordance with the disclosure, this apparatus also shown with a commercial syringe placed in a testing position, and including other parts shown schematically.

FIG. 3 is a schematic view of a third embodiment of a testing apparatus in accordance with the disclosure.

FIG. 4 is a flowchart illustrating programing for a control circuit useful in some embodiments.

### DETAILED DESCRIPTION

As noted above, a method of administering a liquid food product can comprise the liquid food product into a measuring apparatus, the measuring apparatus having a stand, a fluid container, and a valve, and a receptacle disposed beneath the fluid container. For IDDSI testing purposes, under the current framework, the aliquot comprises 10 mL of liquid food product and the fluid container having the dimensions of a 10 ml syringe conforming to ISO 7886-1:2017 and the predetermined time period comprises 10 seconds. The fluid container preferably is graduated. In many cases, the container may comprise a standard commercial syringe. In other cases, a container conforming to the shape of such syringe may be employed.

At the option of the user or care facility, the liquid food product may be tested at the temperature intended for serving, for example, a cold temperature in the case of a cold liquid beverage, or a hot temperature in the case of a soup or other hot food product. Alternatively, the liquid food product may be tested at a standardized temperature, such as a temperature at a range between 22-25 degrees C. The evaluation of the liquid fluid may be characterized in accordance with the IDDSI scale as noted above, or with any other suitable scale.

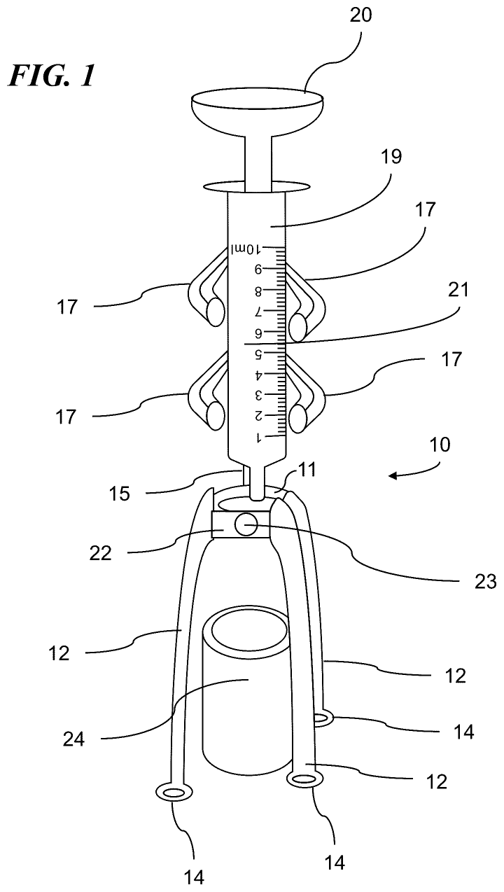

Generally, the testing method is performed using one or more embodiments of the testing devices described herein. With reference now to FIG. 1, the testing apparatus 10 includes a hub 11 supported by three legs 12. The legs 12 are equipped with leg levelers 14 at the distal ends thereof. Protruding from the hub 11 is rod 15 that supports a syringe holder 17. The syringe holder 17 supports a syringe 19. Shown further is an optional funnel 20 used to assist in introducing the liquid food product into the syringe 19. The syringe 19 includes graduation marks 21 to allow the user to determine the volume of liquid in the syringe 19 both during the introduction of the liquid food product and after fluid has been discharged during the testing process. The illustrated syringe 19 is a standard disposable commercial syringe which is intended to be oriented in the opposite direction for filling. Accordingly, the graduation marks 21 are thus inverted from the perspective of the user.

Although a manually controlled valve may be provided, the illustrated apparatus 10 includes a timer-controlled valve 22 that is provided with a power source such as a battery (not shown). The timer-controlled valve is operated by a manual actuator button 23. When the button is depressed, the valve quickly opens and remains open for ten seconds, then closes quickly. The apparatus includes a receptacle 24 beneath the valve to catch the fluid that is discharged from the syringe 19. The illustrated apparatus is intended to be typically inexpensive relative to the other devices shown herein and to be very easy to use and store. This apparatus is suitable for occasional home use by a dysphagic patient in self-administration of a liquid food product, or for other light commercial usage.

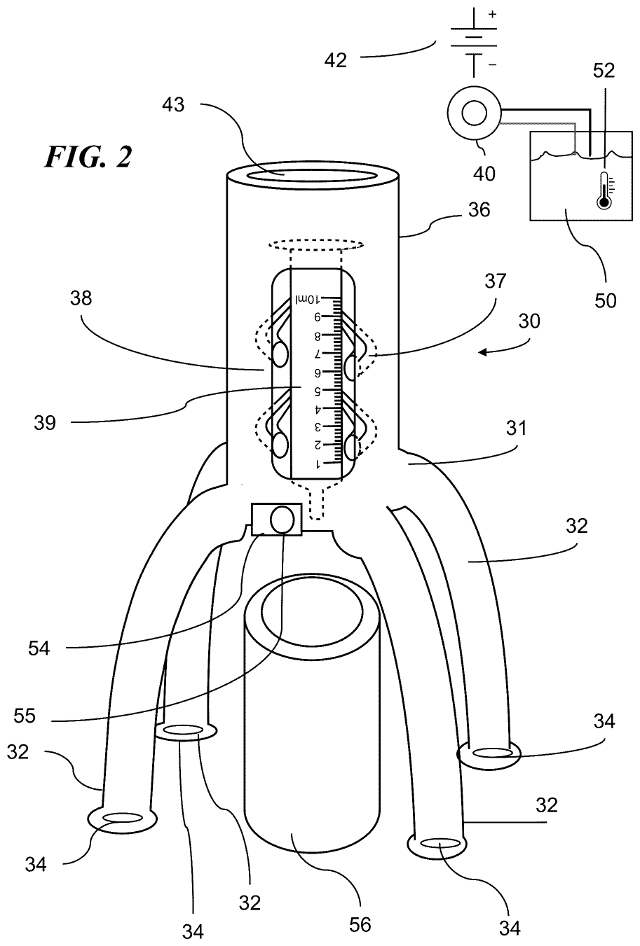

A more fully featured apparatus 30 is shown in FIG. 2. In this apparatus, the hub 31 is supported by four legs 32 each including leg levelers 34. The hub 31 supports a cylindrical housing 36 that includes an internal syringe holder 37 and a viewing aperture 38. The apparatus as illustrated includes an optional pump 40 connected to a power source, which, in the illustrated embodiment, is a battery 42.

The housing 36 defines a chamber 43 that provides some protection from ambient temperature fluctuations. The apparatus includes a fluid reservoir 50 which may be provided with a stirrer (not shown) and a temperature sensor 52. As with apparatus 10, the illustrated apparatus 30 includes a syringe 39, a timer-controlled valve 54 and a user actuating button 55, and a receptacle 56 disposed beneath the valve and fluid container. This device is intended to be used in a commercial setting where many tests might be run at mealtimes. The illustrated syringe is again a commercial syringe, but instead a purpose-built syringe with graduation marks oriented upwardly in the direction of normal use of the apparatus 30 could be used.

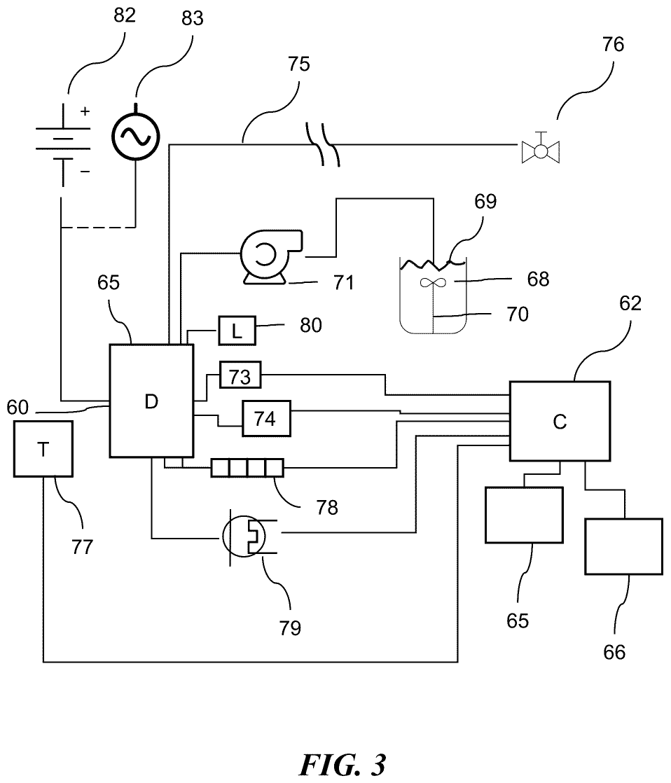

The more robust system illustrated in FIG. 3 comprises a dispensing apparatus 60 otherwise similar in configuration to the dispensing apparatus 30 shown in FIG. 2. The system is provided with a control circuit 62 that may have a user interface such as a screen 65 and/or a network interface 66 which may a Bluetooth or Wi-Fi network interface or other suitable interface. A fluid reservoir 68 contains a liquid food 69 to be measured and a stirrer 70. As shown, the reservoir 68 fluidically communicates with the device 60 and includes a mechanism to transfer fluid from the reservoir 68 to the device 60. As shown, the apparatus is equipped with a centrifugal pump 71 equipped to dispense the liquid fluid into the testing apparatus 60. Preferably, the pump is configured to meter a precise amount of fluid, such as 10 mL, into the testing apparatus 60.

For purposes of determining the amount of fluid in the syringe when filling or the amount of fluid remaining in the syringe at of the conclusion of the test, the device may be equipped with a camera 73 and/or a ranging laser reader 74. These may be communicatively connected to the control circuit 62. The control circuit 62 may be configured in turn to display the results of the test digitally to the user via screen 65 or which may communicate the devices over the network interface 66. The timer controlling the timer-controlled valve may be integral with or separate from the control circuit.

The illustrated device is configured with a hot water flush line 75 connected to a source of heated water 76, such as a house water line. This may be used to flush the device between uses.

The testing apparatus 60 may include a temperature sensor 77, which may communicate electronically with the control circuit 62, as shown. The testing apparatus 60 may also include a heater 78 and/or a cooler 79, which may be useful when evaluating the viscosity of liquid food products at different temperatures and which may be operatively connected to the control circuit 62 as shown. The apparatus may include a level 80, such as laser level or bubble level. Finally, the apparatus may draw power from a battery 82 or source of alternating current 83 as appropriate. In practice, the testing system may include some or all of the components shown in FIG. 3 or additional components as may be found suitable. An apparatus configured as shown in FIG. 3 is best suited for use by manufacturers of pre-thickened food products.

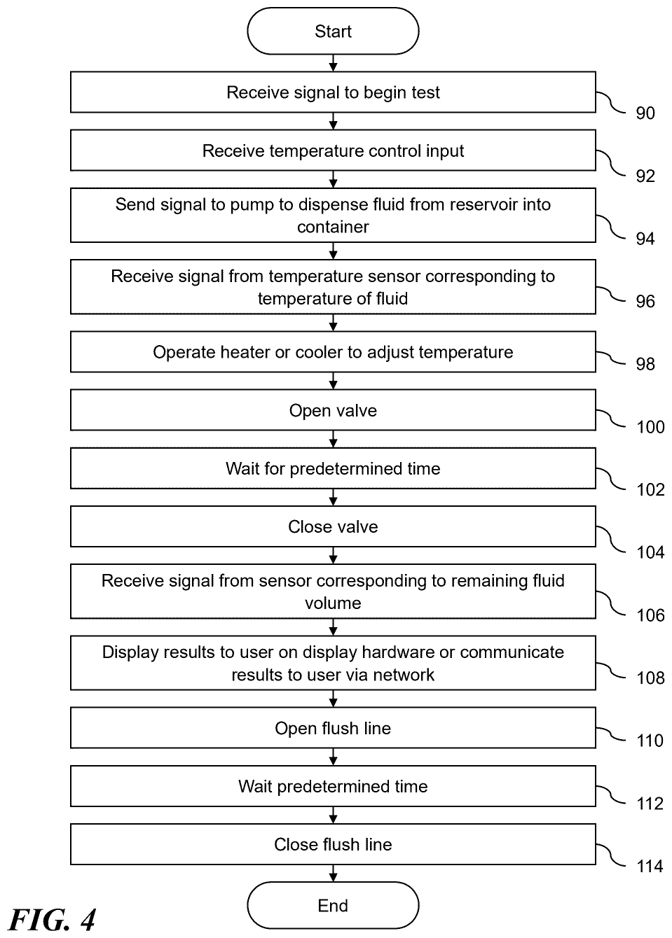

The control circuit may be programmed with suitable programming to accomplish the results described herein. With reference to FIG. 4, the control circuit may be programmed with a series of logical steps as described in this figure. At step 90, the control circuit may receive a signal from a user, via a user interface, to begin a test. The apparatus may be calibrated using a solution of known IDDSI flow properties in advance of the test (steps not shown). Optionally, at step 92, from the user may be received an input corresponding to desired temperature of the liquid at which the test is to be run. As seen at step 94, the control circuit then may send a signal to the pump to dispense fluid from the reservoir into the container. As seen in step 96, optionally the control circuit may receive a signal from the temperature sensor corresponding to the temperature of the fluid. If desired, and if a temperature control input has been received at step 92, the control circuit may send a signal to operate the heater or cooler to adjust the temperature accordingly, with appropriate temperature sensing and feedback to obtain the correct temperature.

At step 100, the control circuit sends a signal to open the valve. At step 102, after waiting for a predetermined time, the valve is closed at step 104. The predetermined time will be 10 seconds in the case of the IDDSI protocol discussed herein but other types of tests may involve a different predetermined time.

At step 106, the sensor receives a signal from a sensor corresponding to the fluid volume remaining in the testing apparatus. These results then, at step 108, are displayed to the user on display hardware or are communicated to the user via a network. Optionally, at steps 110-114, the controller may be programmed to open a flush line, waiting a predetermined time to allow the flush water to clean the system, and may send a signal to close the flush line to complete the flushing process.

The apparatus may be formed from any suitable materials. For example, with reference to FIGS. 1 and 2, the hub and legs may be formed from plastic, metal, or other suitable materials. The legs may be provided with height adjustment features (not shown) if desired. Any suitable materials and components may be used for the more robust system shown in FIG. 3. The syringe may be a disposable plastic syringe, or a more durable syringe such as a plastic or glass, or steel syringe may be employed. The holders for the syringe may comprise molded plastic, silicone-coated metal, or other suitable material. The fluid receptacle may be connected directly to a disposal system, or may be simply a manually removable container. The temperature sensor may be a thermometer or may be a digital temperature or other suitable temperature sensor. The apparatus may be equipped with lights (not shown) to enhance visibility. The control circuit may include an application-specific integrated circuit or a microcontroller or other suitable device.

If the liquid food product is deemed suitable for administration to a dysphagic patient or to a cohort of dysphagic patients, the liquid food product may be so administered. Alternatively, the viscosity of the liquid food product may be adjusted. Many liquid food products are thickened immediately prior to use by adding a solid or liquid thickener, such as the THICK-IT line of thickeners sold by Kent Precision Foods Group. If the caregiver (which may be the dysphagic person himself or herself) determines from the test that the liquid food product is too thin, the caregiver may add additional thickener. The caregiver conversely may thin the liquid food product with water or unthickened product if caregiver determines that the liquid food product is too thick.

The disclosure has been described with reference to the IDDSI Framework and Testing Method indicated above, but the devices and methods discussed herein may be used with other dysphagia protocols. The testing apparatus and method described herein are designed in this context to complement the IDDSI testing protocol, replacing the manual release of fluid from the syringe with an automated release.

The devices described herein may be used in other contexts. For example, it is envisioned that under appropriate protocols the viscosity measuring devices may be used to measure the viscosity of other liquids or slurries or, more generally, to test the flow properties of flowable materials. For example, a device as disclosed herein may be used to evaluate the flow properties of uncured cements, uncured concretes, resins, oils, uncured adhesives, powdered products such as talc, crystalline products such as salts, and so forth. Such other products can be placed into a fluid container or reservoir instead of a liquid food product as described hereinabove, and otherwise evaluated as described herein.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. Any description of certain embodiments as “preferred” embodiments, and other recitation of embodiments, features, or ranges as being preferred, or suggestion that such are preferred, is not deemed to be limiting. The invention is deemed to encompass embodiments that are presently deemed to be less preferred and that may be described herein as such. All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

1. A method of administering a liquid food product to one or more dysphagic patients, comprising:
introducing an aliquot of liquid food product into a measuring apparatus, the measuring apparatus comprising a stand supporting a fluid container and a valve, and a receptacle disposed beneath the fluid container;
actuating the valve to release liquid food product from the fluid container into the receptacle for a predetermined time period;
measuring the amount of liquid food product remaining in the fluid container;
determining from the amount of liquid food product remaining in the fluid container whether the liquid food product is of a viscosity appropriate for the one or more dysphagic patients; and
administering the liquid food product to one or more dysphagic patients only if the liquid food product is of an appropriate viscosity.

2. A method according to claim 1, the aliquot comprising 10 ml of liquid food product, the fluid container and having the dimensions of a 10 ml syringe conforming to ISO 7886-1:2017, and the predetermined time period comprising ten seconds.

3. A method according to claim 1, the liquid food product being at a temperature intended for serving.

4. A method according to claim 1, the liquid food product being at a temperature between 22°-25° C.

5. A method according to claim 1, the measuring apparatus comprising a temperature sensor configured to evaluate the temperature of the liquid fluid inside the container.

5. (canceled)

6. A method according to claim 1, the measuring apparatus comprising a housing and a holder sized to retain a removable syringe.

7. A method according to claim 1, including a pump configured to introduce liquid food from a reservoir into said fluid container.

8. A method according to claim 7, the reservoir including a stirring apparatus.

9. A method according to claim 7, one or more of the pump and the reservoir including a temperature sensor.

10. A method according to claim 1, said valve being a timer-controlled valve.

11. A viscosity testing apparatus comprising:
a stand supporting a fluid container and a timer-controlled valve, and a receptacle disposed beneath the fluid container, the fluid container comprising graduations; and
a temperature sensor configured to evaluate the temperature of liquid fluid inside the container.

12. A viscosity testing apparatus according to claim 11, comprising a reservoir and a liquid food product contained in the reservoir.

13. A viscosity testing apparatus according to claim 11, comprising a reservoir and an oil contained in the reservoir.

14. A viscosity testing apparatus according to claim 11, comprising a reservoir and an uncured concrete contained in the reservoir.

15. A viscosity testing apparatus according to claim 11, comprising a reservoir and an uncured adhesive contained in the reservoir.

16. A viscosity testing apparatus according to claim 11, comprising a pump equipped to dispense fluid from a reservoir into the container.

17. A viscosity testing apparatus according to claim 16, comprising a control circuit configured to open said timer-controlled valve for a predetermined time period, and to cause said pump to transfer a predetermined amount of fluid from the reservoir into the container.

18. A viscosity testing apparatus according to claim 11, comprising a heater.

19. A viscosity testing apparatus according to claim 11, comprising a control circuit configured to display the results of a viscosity measurement test digitally to a user.

20. A viscosity testing apparatus according to claim 11, comprising a reservoir and a liquid food product contained in the reservoir, a pump equipped to dispense fluid from a reservoir into the container, a control circuit configured to open said timer-controlled valve for a predetermined time period, and to cause said pump to transfer a predetermined amount of fluid from the reservoir into the container, the control circuit configured to display the results of a viscosity measurement test digitally to a user.

21. A method according to claim 1, the measuring apparatus including a level.
